(19) United States
(12) Patent Application Publication
(10) Pub. No.: US 2025/0044447 A1
(43) Pub. Date: Feb. 6, 2025

(54) ITOF DEPTH CALCULATION APPARATUS AND METHOD, AND ITOF CAMERA MODULE AND SYSTEM

(71) Applicant: ZHEJIANG SUNNY OPTICAL INTELLIGENCE TECHNOLOGY CO., LTD., Zhejiang (CN)

(72) Inventors: Guanhua YU, Zhejiang (CN); Renrui QIAN, Zhejiang (CN); Ke XIANG, Zhejiang (CN); Kejie YI, Zhejiang (CN)

(73) Assignee: ZHEJIANG SUNNY OPTICAL INTELLIGENCE TECHNOLOGY CO., LTD., Zhejiang (CN)

(21) Appl. No.: 18/716,591

(22) PCT Filed: Oct. 25, 2022
(86) PCT No.: PCT/CN2022/127317

§ 371 Date: Jun. 5, 2024

(30) Foreign Application Priority Data
Dec. 10, 2021 (CN) 202111509305.1

(51) Int. Cl. G01S 17/08; G06T 3/60; G06T 7/521

(52) U.S. Cl. CPC G01S 17/08; G06T 3/60; G06T 7/521; G06T 2207/10028

(57) ABSTRACT

An Indirect time time-of-flight (iToF) depth calculation device and method, and an iToF camera module and a system, including an interface input module, a frame parsing module, a gray scale calculation module, a phase calculation module, a phase correction module, a depth calculation module, a depth filtration module, an interface output module, a control module and a cache module. According to the device, method, module, system, the configuration parameters of each module in the iToF depth calculation device can be configured and adjusted according to different types of camera modules to support different types of camera modules; moreover, the output results are final depth value and gray scale value or final point cloud value and gray scale value, eliminating the need for further calculations or adjustments; in addition, the hardware implementation of this iToF depth calculation device enables the parallel processing of data, resulting in enhanced processing speed.

### TECHNICAL FIELD

This application relates to the field of chip architecture design, in particular to an iToF depth calculation device and method, and an iToF camera module and a system.

### BACKGROUND

iToF, short for indirect Time-of-Flight, refers to measuring light travel time indirectly through the measurement of phase shifts instead of directly measuring the flight time of light.

In this method, modulated infrared light signals are transmitted into a scene, a sensor receives light signals reflected back from a target object in the scene, and then the phase difference between the transmitted and received signals is calculated based on the accumulated charge within the exposure time, so as to obtain the depth of the target object.

There are various types of iToF camera chips available in the market now, which can be classified as follows:
1. based on frequency count: single-frequency, dual-frequency;
2. based on exposure count: single-exposure, dual-exposure;
3. based on resolution: VGA, QVGA, 720p, and other formats;
4. based on application scenario: linear array, area array;
5. based on MIPI (Mobile Industry Processor Interface) format type: RAW8, RAW12, RAW16, etc.

IToF camera-based development may face several issues.

1. For secondary application development, users need to individually design hardware according to different camera modules, leading to increased hardware development costs, longer development cycles, and decreased development efficiency. Current camera modules only output phase data, requiring further analysis, calibration, calculation, filtration, etc., to obtain the final depth information or 3D point cloud data. In contrast, modules equipped with iToF chips directly output the depth and other desired information values, which poses significant development difficulties for users lacking a background in optics.

2. In application development, users need to understand the entire depth calculation process for different iToF cameras, leading to increased design complexity and entry threshold.

### SUMMARY

To address the above issues existing in the prior art, this application proposes a novel iToF depth calculation device and method, and an iToF camera module and a system that can support various iToF camera modules, provide outputs that do not require further calculations or adjustments by users, and enable parallel data processing.

According to a first aspect of the application, an iToF depth calculation device is provided, comprising:
a frame parsing module, configured to convert optical signal information into parsed information, the parsed information comprising four-phase delay data, and the frame parsing module calculating a phase difference according to the four-phase delay data;
a phase calculation module, configured to calculate a phase value according to the phase difference;
a phase correction module, configured to correct the phase value to obtain a corrected phase value;
a depth calculation module, configured to perform depth calculation on the corrected phase value to obtain a depth value; and
a depth filtration module configured to filter the depth value to obtain a filtered depth value.

According to a second aspect of the application, an iToF depth calculation method is provided, comprising:
converting, by a frame parsing module, optical signal information into parsed information, the parsed information comprising four-phase delay data, and the frame parsing module calculating a phase difference according to the four-phase delay data;
calculating, by a phase calculation module, a phase value according to the phase difference;
correcting, by a phase correction module, the phase value to obtain a corrected phase value;
performing, by a depth calculation module, depth calculation on the corrected phase value to obtain a depth value; and
filtering, by a depth filtration module, the depth value to obtain a filtered depth value.

According to a third aspect of the application, an iToF camera module is provided, comprising the iToF depth calculation device as described in the first aspect, wherein
the iToF depth calculation device is configured to process optical signal information to obtain depth value information and gray scale value information or point cloud value information and gray scale value information.

According to a fourth aspect of the application, an iToF depth calculation system is provided, comprising an iToF camera module, an AP chip and the iToF depth calculation device as described in the first aspect, wherein
the iToF camera module is configured to output optical signal information, the optical signal information is processed by the iToF depth calculation device to obtain depth value information and gray scale value information or point cloud value information and gray scale value information, and
the AP chip is configured to receive the depth value information and the gray scale value information or the point cloud value information and the gray scale value information.

According to a fifth aspect of the application, an iToF depth calculation system is provided, comprising the iToF camera module as described in the third aspect and an AP chip, wherein
the iToF depth calculation device in the iToF camera module is configured to process optical signal information to obtain depth value information and gray scale value information or point cloud value information and gray scale value information, and
the AP chip is configured to receive the depth value information and the gray scale value information or the point cloud value information and the gray scale value information.

According to the iToF depth calculation device and method, and the iToF camera module and the system provided by the application, the configuration parameters of each module in the iToF depth calculation device can be configured and adjusted according to different types of camera modules, so as to support different types of camera modules; moreover, the output results are the final depth value and gray scale value or the final point cloud value and gray scale value, eliminating the need for further calculations or adjustments; in addition, the hardware implementation of this iToF depth calculation device enables the parallel processing of data, resulting in enhanced processing speed.

### BRIEF DESCRIPTION OF THE DRAWINGS

In order to explain the technical scheme in the embodiments of the application more clearly, the drawings used in the description of the embodiments will be briefly introduced below. Obviously, the drawings in the following description are only some embodiments of the application. For those of ordinary skill in the art, other drawings can be obtained from these drawings without exceeding the scope of this application.

FIG. 1 is a connection diagram of an iToF depth calculation system according to an embodiment of the application.

FIG. 2 is a first structural diagram of an iToF depth calculation device according to an embodiment of the application.

FIG. 3 is a second structural diagram of an iToF depth calculation device according to an embodiment of the application.

FIG. 4 is a third structural diagram of an iToF depth calculation device according to an embodiment of the application.

FIG. 5 is a fourth structural diagram of an iToF depth calculation device according to an embodiment of the application.

FIG. 6 is a fifth structural diagram of an iToF depth calculation device according to an embodiment of the application.

FIG. 7 is a flowchart of an iToF depth calculation method according to an embodiment of the application.

FIG. 8 is a connection diagram of another iToF depth calculation system according to an embodiment of the application.

### DETAILED DESCRIPTION OF EMBODIMENTS

The technical scheme in the embodiments of the application will be described clearly and completely with reference to the drawings in the embodiments of the application. Obviously, the described embodiments are part of the embodiments of the application, not all of them. All other embodiments obtained by those of ordinary skill in the art based on the embodiments in this application without paying creative effort fall within the scope of this application.

In this application, a control module of an iToF depth calculation device configures and adjusts configuration parameters of each module in the iToF depth calculation device according to different types of camera modules, so that each module in the iToF depth calculation device can correctly process the data input by different types of camera modules, and finally output the final depth value and gray scale value or the final point cloud value and gray scale value. Therefore, the iToF depth calculation device of the application can support different types of camera modules, and the output results do not require any additional calculations or adjustments by users; users do not need to understand the entire depth calculation process for different iToF cameras, which reduces design complexity and entry threshold; in addition, the hardware implementation of this iToF depth calculation device enables the parallel processing of data, resulting in enhanced processing speed.

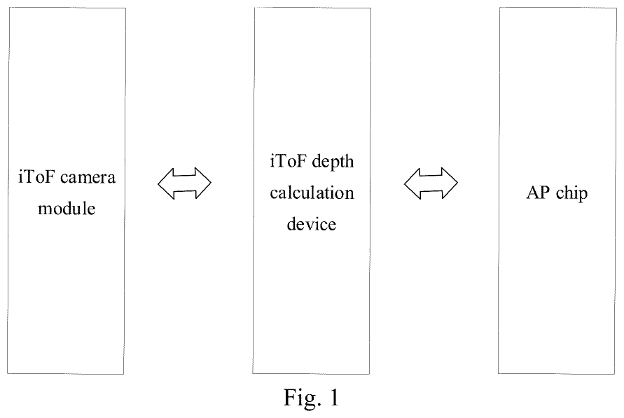

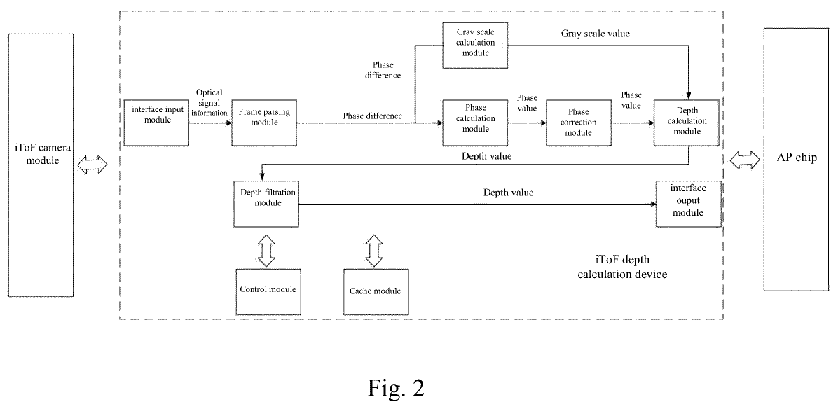

FIG. 1 is a connection diagram of an iToF depth calculation system according to an embodiment of the application. As shown in FIG. 1, the iToF depth calculation system comprises an iToF camera module, an iToF depth calculation device and an AP chip. An input interface of the iToF depth calculation device is connected with the iToF camera module, and an output interface is connected with the AP (Application Processor) chip. The camera module inputs optical signal information into the iToF depth calculation device, and the iToF depth calculation device processes the optical signal information to obtain the final depth value and gray scale value or the final point cloud value and gray scale value, and then outputs the final depth value and gray scale value or the final point cloud value and gray scale value to the AP chip. The specific structure of the iToF depth calculation device shown in FIG. 1 can be found in FIGS. 2-6.

FIG. 2 is a first structural diagram of an iToF depth calculation device according to an embodiment of the application. As shown in FIG. 2, the iToF depth calculation device comprises an interface input module, a frame parsing module, a gray scale calculation module, a phase calculation module, a phase correction module, a depth calculation module, a depth filtration module, an interface output module, a control module and a cache module.

In FIG. 2, the interface input module is configured to receive the optical signal information from the iToF camera module and send the optical signal information to the frame parsing module. The interface input module comprises an MIPI interface input module. The interface input module can be connected with a camera module (for example, iToF camera module), and the configuration of the interface input module can be modified through the configuration of the control module to adapt to the interface timing of different camera modules and receive the optical signal information converted by the camera module.

In FIG. 2, the frame parsing module is configured to convert the optical signal information into parsed information, the parsed information comprises four-phase delay data, and a phase difference is calculated according to the four-phase delay data. The frame parsing module supports inputs of different camera module modes, such as single frequency single exposure, single frequency dual exposure, dual frequency single exposure, dual frequency dual exposure, and ambient light. The corresponding frame formats comprise 4-phase, 8-phase, 9-phase, 16-phase, and 17-phase. The four-phase delay data comprise single frequency (4-phase), dual frequency (8-phase), dual frequency dual exposure (16-phase), and ambient light (17-phase) data.

In addition, the frame parsing module can selectively parse information such as temperature and exposure time in the frame format as needed.

In FIG. 2, the gray scale calculation module calculates a gray scale value according to the phase difference. The calculated gray scale value will be output by the interface output module. In addition, the gray scale value may be used in the depth calculation module and the depth filtration module.

In FIG. 2, the phase calculation module calculates a phase value according to the phase difference. The phase calculation module reads the four-phase (0°, 90°, 180°, 270°) delay data from the cache module, and converts the phase data measured by orthogonal sampling technology to obtain the phase value. By converting the phase value, the time from transmission to reception of optical signals of the iToF camera module can be obtained. The phase calculation module utilizes the orthogonality of four-phase data for phase calculation and then outputs the phase value.

In FIG. 2, the phase correction module corrects the phase value to obtain a corrected phase value. Due to the limitation of components, a square wave generated by a laser projector is not an ideal square wave, and modulation does not yield an ideal sinusoidal wave either. This leads to nonlinear errors, that is, there is a deviation between the measured phase difference and an ideal phase difference. Therefore, compensation and correction are required for the phase value.

According to one aspect, the temperature rise in the iToF camera module leads to measurement errors, which mainly influences two factors: chip and light source. For the chip, there is a situation where the measured depth value increases due to the temperature rise. This phenomenon, which is linearly related to temperature, is called temperature drift. For the light source, the emission wavelength of the light source undergoes redshift as the temperature increases, causing a discrepancy between the wavelength used for depth calculation and the actual wavelength, resulting in depth measurement errors. Without temperature calibration, it is easy to imagine that for the same distance, as the temperature rises, the depth fed back by the iToF camera module continues to increase, potentially leading to incorrect judgments and decisions by technicians or users. By using algorithms to derive a set of best-fit parameters for temperature and phase compensation, the current phase value is compensated, thus improving the accuracy of the measurement. Temperature information can be used to obtain phase compensation, and then the phase value can be corrected based on the phase compensation. The temperature information can be provided by the frame parsing module through parsing.

According to another aspect, when capturing a white wall at a specific distance, it is theoretically expected to obtain a flat depth plane, as each pixel captures in the same distance. However, in practice, a slightly undulating surface is obtained, that is, each pixel has its own distance deviation, hence requiring phase compensation for each pixel. The compensation value is calculated based on calibration information of the iToF camera module.

The phase correction module can selectively enable one or more correction functions to perform phase correction on the phase difference according to actual needs, and then output the corrected phase difference.

In FIG. 2, the depth calculation module performs depth calculation on the corrected phase value and obtains a depth value. The depth calculation module converts the corrected phase value into an actual depth value, and if it is a dual-frequency system, the calculation needs to be performed twice.

The depth calculation module determines the duration of one cycle by modulating the frequency, and then uses the proportion of the corrected phase value within one cycle to calculate the flight time of the light signal, which is then multiplied by the speed of light to result in a depth distance value. Then the depth value is output.

In FIG. 2, the function of the depth filtration module is to filter out pixels that do not conform to the image features. The depth filtration module filters the depth value calculated by the depth calculation module to obtain a filtered depth value. The optical signals emitted by the iToF camera are refracted and reflected on a surface of a target object, or undergo secondary reflection on other object surfaces, and then received by a sensor through a lens, impacting the information of certain pixels. These pixels need to be filtered out.

Regarding depth filtration, a specific approach can involve scanning each pixel in the image utilizing a template and assessing whether the central pixel and pixels within the template-defined neighborhood fall within the same distance range. In a case where the central pixel has a considerable distance deviation, this pixel is considered an outlier and needs to be filtered out.

Users can select one or more depth filtration modules to filter the depth value as needed, and the depth filtration module filters out pixels that are not required or have an impact on valid data according to parameters configured by the control module, and outputs the final depth value.

In FIG. 2, the interface output module outputs the filtered depth value and gray scale value. The interface output module can be an MIPI interface output module. The interface output module outputs the final data in combination according to a certain data format, and can be connected to an AP chip, facilitating secondary development by users. The AP chip allows for secondary development based on the depth value and/or the gray scale value.

In FIG. 2, the control module configures the configuration parameters of each module in the iToF depth calculation device. The control module can be a CPU, equipped with interfaces such as SPI (Serial Peripheral Interface), I2C and AXI (Advanced eXtensible Interface). The control module is responsible for the management and configuration of each module and the iToF camera module and plays a coordinating role.

In FIG. 2, the cache module stores the configuration parameters and processed data from each module in the iToF depth calculation device.

After the iToF depth calculation device is powered on normally, the control module initializes the iToF camera module through I2C, and configures the exposure time, sampling frequency, single and dual frequency, frame rate, resolution and other parameters.

The iToF camera module will emit a sine wave narrow-band optical signal with a fixed frequency, the optical signal will be reflected by an object and then received by a photosensitive sensor of the iToF camera module, and the received optical signal will be quantitatively analyzed. The iToF camera module samples a group of data every quarter period and outputs data through the interface output module.

The control module reads parameters or data such as correction parameter, filtration parameter and point cloud parameter from the cache module, and configures the read parameters or data into related modules or caches.

The control module configures the data format and resolution of the interface input module.

The interface input module receives and analyzes the data according to configurations, and converts the data into the iToF module frame format (DVP format data) and outputs the same to the frame parsing module.

After receiving the data of the iToF module frame format, the frame parsing module extracts the required four-phase data or other information (such as temperature) according to the parameter information configured by the control module. In one embodiment, the four-phase data can be temporarily stored in the cache module, and the temperature information can be transmitted to the phase correction module.

The iToF module frame formats actually received by the frame parsing module are shown in the following table:

Frame format 1:

Dual frequency dual exposure mode 1

| Frequency 0 | | | | Frequency 1 | | | | Frequency 0 | | | | Frequency 1 | | | | Ambient |
|---|---|---|---|---|---|---|---|---|---|---|---|---|---|---|---|---|
| low exposure | | | | low exposure | | | | high exposure | | | | high exposure | | | | light |
| qc | q1 | q2 | q3 | q0 | q1 | q2 | q3 | q0 | q1 | q2 | q3 | q0 | q1 | q2 | q3 | i |

Frame format 2:

Dual frequency dual exposure mode 2

| Ambient | Frequency 0 | | | | Frequency 1 | | | | Frequency 0 | | | | Frequency 1 | | | |
|---|---|---|---|---|---|---|---|---|---|---|---|---|---|---|---|---|
| light | low exposure | | | | low exposure | | | | high exposure | | | | high exposure | | | |
| i | q0 | q1 | q2 | q3 | q0 | q1 | q2 | q3 | q0 | q1 | q2 | q3 | q0 | q1 | q2 | q3 |

Frame format 3:

Dual frequency single exposure mode

| | | |
|---|---|---|
| Ambient | Frequency 0 | Frequency 1 |
| light | high exposure | high exposure |

| | | | | | | | | |
|---|---|---|---|---|---|---|---|---|
| i | q0 | q1 | q2 | q3 | q0 | q1 | q2 | q3 |

Frame format 4:

Single frequency dual exposure

| | | |
|---|---|---|
| Ambient | Frequency 0 | Frequency 0 |
| light | low exposure | high exposure |

| | | | | | | | | |
|---|---|---|---|---|---|---|---|---|
| i | q0 | q1 | q2 | q3 | q0 | q1 | q2 | q3 |

Frame format 5:

Single frequency single exposure

| | |
|---|---|
| Ambient | Frequency 0 |
| light | high exposure |

| | | | | |
|---|---|---|---|---|
| 1 | q0 | q1 | q2 | q3 |

The configuration of the iToF camera module is known, and the corresponding resolution, phase frame count, type (high/low frequency, high/low exposure), and ROI (Region of Interest) resolution can be configured by the control module, so that the frame parsing module can filter, parse and classify the received data, and finally save the information in the corresponding addresses of the cache module, for example, low-frequency information is placed in Area 0 and high-frequency information is placed in Area 1.

Because the output formats of iToF camera modules from different manufacturers may be different, the frame parsing module needs to have some flexibility. For example, it should be able to extract auxiliary information from a specified position of a specified frame according to configuration. Furthermore, to ensure compatibility, the frame parsing module also allows the generation of an interrupt after completing the writing of a large frame of data, enabling the control module to parse relevant information from the cache module data.

3DCP supports the data collection of the iToF camera module by utilizing four phases, resulting in the formation of four small frames (Q0, Q1, Q2, Q3). Within each small frame, a particular pixel is calculated from the raw data of the iToF camera module. Taking a 640×480 resolution as an example, Sony's iToF camera module produces 1280 raw data per row, and adjacent raw data pairs are computed (added or subtracted) to derive the pixel value.

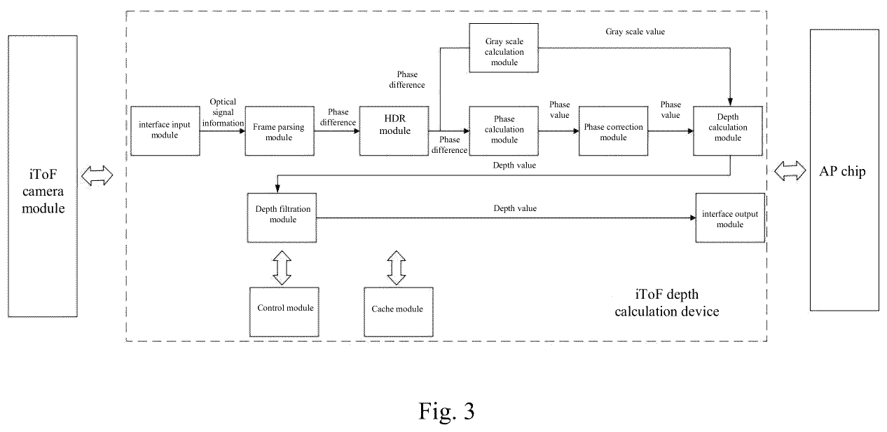

FIG. 3 is a second structural diagram of an iToF depth calculation device according to an embodiment of the application. In FIG. 3, the iToF depth calculation device further comprises an HDR (High-Dynamic Range) module in addition to the modules shown in FIG. 2. The HDR module is configured to read the phase difference, and perform HDR calculation on the long and short exposure characteristics of each pixel according to exposure time information, so as to obtain an HDR-calculated phase difference, wherein the phase calculation module calculates the phase value according to the HDR-calculated phase difference. The exposure time information can be exposure time information provided by the frame parsing module through parsing.

The HDR module is valid only in a dual exposure mode. The HDR module reads four-phase data from the cache module, and performs HDR calculation on the long and short exposure characteristics of each pixel according to the parameters configured by the control module. In a non-dual exposure mode, the HDR module does not process information.

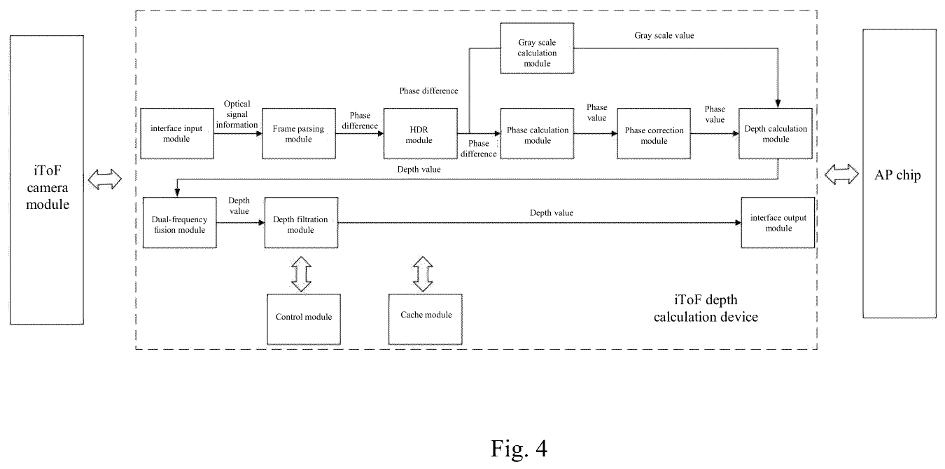

FIG. 4 is a third structural diagram of an iToF depth calculation device according to an embodiment of the application. In FIG. 4, the iToF depth calculation device further comprises a dual-frequency fusion module in addition to the modules shown in FIG. 3. In a dual-frequency mode, the depth value calculated by the depth calculation module comprises a first depth value and a second depth value, the dual-frequency fusion module is configured to perform dual-frequency fusion calculation on the first depth value and the second depth value, so as to obtain a dual-frequency fused depth value, and the depth filtration module filters the dual-frequency fused depth value to obtain the filtered depth value.

The dual-frequency fusion module is valid only in the dual-frequency mode, in which case it introduces an additional frequency-modulated wave for frequency mixing. When targeting objects at the same distance, each modulated wave measurement yields a distinct, uncertain distance. However, the true distance is a value obtained by the measurement of both frequency-modulated waves, and the corresponding frequency at that position is the greatest common divisor of multiple frequencies, consequently expanding the measurement range.

Because the modulated signal is periodic, when targeting objects at the same distance, each modulated wave measurement yields a distinct, uncertain distance. However, the true distance is a value obtained by the measurement of both frequency-modulated waves, and the corresponding frequency at that position is the greatest common divisor of multiple frequencies, consequently expanding the measurement range and outputting the depth value.

The dual-frequency fusion module is not valid in a non-dual-frequency mode and does not process the depth value.

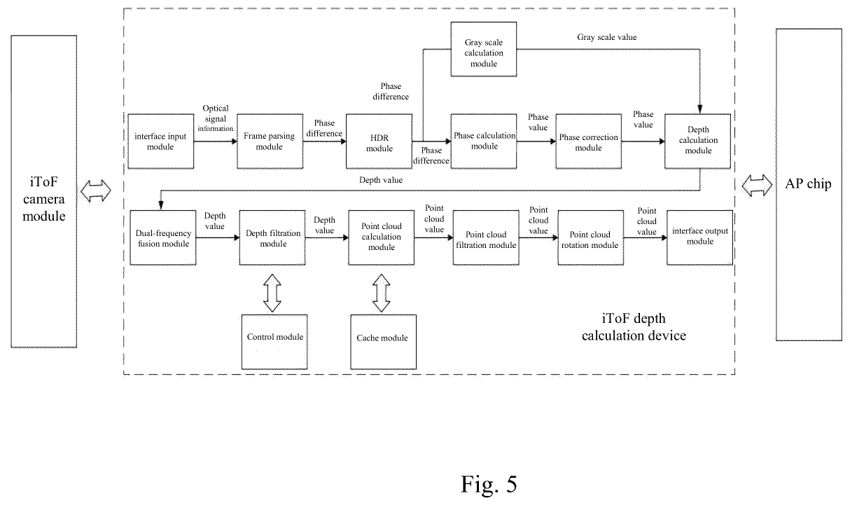

FIG. 5 is a fourth structural diagram of an iToF depth calculation device according to an embodiment of the application. In FIG. 5, the iToF depth calculation device further comprises a point cloud calculation module, a point cloud filtration module and a point cloud rotation module in addition to the modules shown in FIG. 4.

The point cloud calculation module is configured to perform point cloud calculation on the filtered depth value to obtain a point cloud value. The point cloud calculation module reads three-dimensional coordinate parameters of each pixel from the cache module, and performs calculation with the depth value to obtain three-dimensional point cloud data.

The point cloud filtration module is configured to filter the point cloud value to obtain a filtered point cloud value. According to the parameters configured by the control module, the point cloud filtration module filters the three-dimensional point cloud data according to a certain algorithm, so that the edge characteristics of the image are enhanced.

The point cloud rotation module is configured to rotate the filtered point cloud value to obtain a rotated point cloud value. The point cloud rotation module can be turned on as needed. According to the parameters configured by the control module, the point cloud data are rotated by a certain angle, and results are output to the interface output module.

In this way, the point cloud calculation module, the point cloud filtration module and the point cloud rotation module further process the depth value to obtain the rotated point cloud value, and the interface output module outputs the rotated point cloud value and the gray scale value calculated by the gray scale calculation module. The interface output module outputs the final point cloud data according to a certain protocol format, and the back-end AP chip can make secondary development based on the point cloud data and/or the gray scale value.

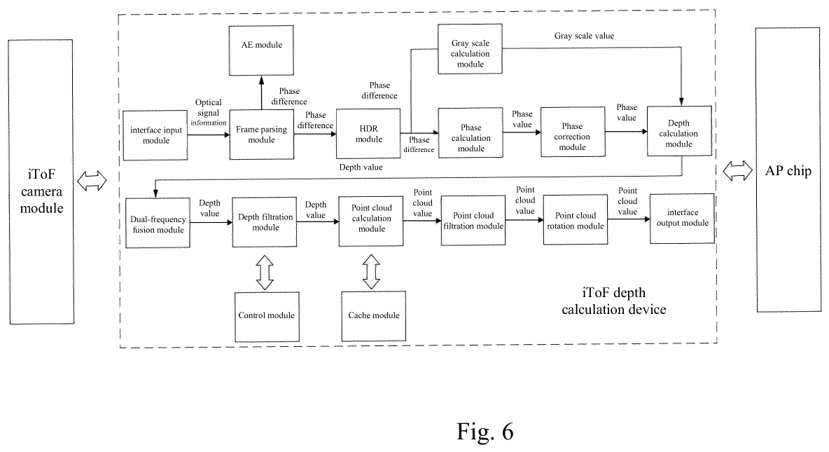

FIG. 6 is a fifth structural diagram of an iToF depth calculation device according to an embodiment of the application. In FIG. 6, the iToF depth calculation device further comprises an AE (Automatic Exposure) module in addition to the modules shown in FIG. 5, which is configured to calculate an exposure value in a current scene according to the phase difference. When the exposure time is fixed, images produced by the iToF camera module can be either too bright or too dark. Only when the exposure automatically changes to an appropriate setting can the camera capture scenes with suitable brightness. The AE module can automatically adjust the exposure value as the scene changes, so as to improve the quality of depth images. The AE module detects changes in the scene based on certain data, calculates the corresponding exposure value using a specific algorithm, and finally indicates the adjustment of the exposure value.

According to the parameters configured by the control module, the AE module obtains an ideal exposure value through calculation with a specific algorithm based on the current exposure value information of the iToF camera module, and outputs the exposure value to the control module. The control module configures the exposure value into the iToF camera module through I2C, so as to realize dynamic exposure adjustment.

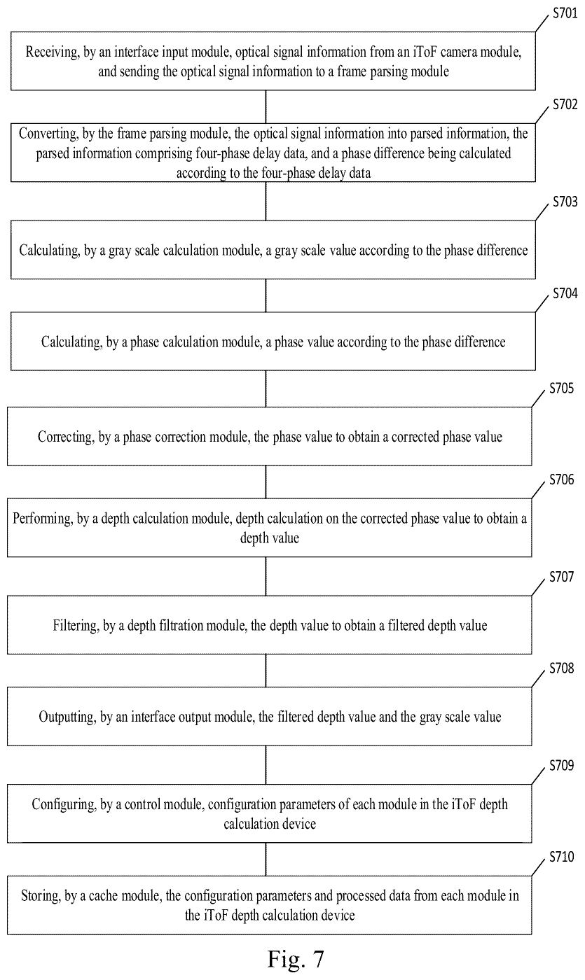

On the basis of the above-mentioned iToF depth calculation device, the application also provides an iToF depth calculation method. FIG. 7 is a flowchart of an iToF depth calculation method according to an embodiment of the application. As shown in FIG. 7, the method comprises the following steps:
step S701, receiving, by an interface input module, optical signal information from an iToF camera module, and sending the optical signal information to a frame parsing module.
S702, converting, by the frame parsing module, the optical signal information into parsed information, the parsed information comprising four-phase delay data, and a phase difference being calculated according to the four-phase delay data;
wherein the parsed information further comprises exposure time information and temperature information;
S703, calculating, by a gray scale calculation module, a gray scale value according to the phase difference;
S704, calculating, by a phase calculation module, a phase value according to the phase difference;
S705, correcting, by a phase correction module, the phase value to obtain a corrected phase value;
wherein S705 comprises: obtaining a phase compensation value by fitting according to the temperature information, and correcting the phase value according to the phase compensation value;
S705 further comprises: calculating a phase compensation value based on calibration information of an iToF module, and correcting the phase value according to the phase compensation value;
S706, performing, by a depth calculation module, depth calculation on the corrected phase value to obtain a depth value;
S707, filtering, by a depth filtration module, the depth value to obtain a filtered depth value;
S708, outputting, by an interface output module, the filtered depth value and the gray scale value;
S709, configuring, by a control module, configuration parameters of each module in the iToF depth calculation device; and
S710, storing, by a cache module, the configuration parameters and processed data from each module in the iToF depth calculation device.

In an embodiment, the iToF depth calculation method further comprises: S711, reading, by an HDR module, the phase difference, and performing HDR calculation on long and short exposure characteristics of each pixel according to the exposure time information, so as to obtain an HDR-calculated phase difference, wherein the phase calculation module calculates the phase value according to the HDR-calculated phase difference.

The depth value comprises a first depth value and a second depth value. In an embodiment, the iToF depth calculation method further comprises: S712, performing, by a dual-frequency fusion module, dual-frequency fusion calculation on the first depth value and the second depth value, so as to obtain a dual-frequency fused depth value; and filtering, by the depth filtration module, the dual-frequency fused depth value to obtain the filtered depth value.

In an embodiment, the iToF depth calculation method further comprises: S713, performing, by a point cloud calculation module, point cloud calculation on the filtered depth value to obtain a point cloud value; S714, filtering, by a point cloud filtration module, the point cloud value to obtain a filtered point cloud value; and S715, rotating, by a point cloud rotation module, the filtered point cloud value to obtain a rotated point cloud value.

In an embodiment, the iToF depth calculation method further comprises: S716, calculating, by an AE module, an exposure value in a current scene according to the phase difference.

In the above implementation, as shown in FIG. 1, the iToF camera module and the iToF depth calculation device are two separate units, the iToF camera module outputs the optical signal information, and the iToF depth calculation device processes the optical signal information. According to another aspect of the application, the iToF depth calculation device can be embedded, integrated or encapsulated in the iToF camera module. In this way, after the iToF camera module and the iToF depth calculation device are combined, the overall size is equivalent to that of a single iToF camera module. The integration of the iToF camera module and the iToF depth calculation device, without requiring additional space, enables the achievement of miniaturization.

The application further provides an iToF camera module, comprising the iToF depth calculation device as shown in FIGS. 2-6. The iToF depth calculation device processes optical signal information to obtain depth value information and gray scale value information or point cloud value information and gray scale value information.

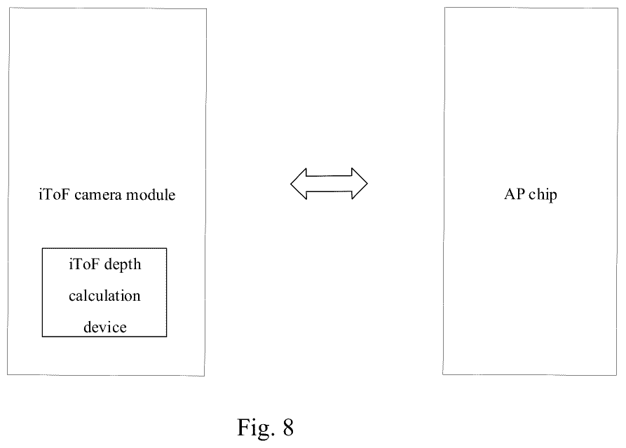

As shown in FIG. 8, corresponding to the iToF camera module in which the iToF depth calculation device is encapsulated, the application also provides an iToF depth calculation system, comprising the iToF camera module in which the iToF depth calculation device is encapsulated, and an AP chip. The iToF depth calculation device in the iToF camera module processes optical signal information to obtain depth value information and gray scale value information or point cloud value information and gray scale value information, and the AP chip is configured to receive the depth value information and the gray scale value information or the point cloud value information and the gray scale value information. The interface type between the iToF camera module and the AP chip may be I2C/SPI or MIPI.

According to the iToF depth calculation device and method, and the iToF camera module and the system provided by the application, the configuration parameters of each module in the iToF depth calculation device can be configured and adjusted according to different types of camera modules, so as to support different types of camera modules; moreover, the output results are the final depth value and gray scale value or the final point cloud value and gray scale value, eliminating the need for further calculations or adjustments; in addition, the hardware implementation of this iToF depth calculation device enables the parallel processing of data, resulting in enhanced processing speed.

The embodiments of the application have been introduced in detail above. Specific examples are applied herein to illustrate the principle and implementation of the application. The above embodiments are only used to help understand the method of the application and its core concepts. The changes or deformations made by those skilled in the art based on the concepts of the application and the specific implementation and application scope of the application are within the scope of the application. To sum up, the content of this specification should not be construed as a limitation to the application.

1-27. (canceled)

28. An indirect time time-of-flight (iToF) depth calculation device, comprising:
a frame parsing module configured to convert optical signal information into parsed information, the parsed information comprising four-phase delay data, and the frame parsing module calculating a phase difference according to the four-phase delay data;
a phase calculation module configured to calculate a phase value according to the phase difference;
a phase correction module configured to correct the phase value to obtain a corrected phase value;
a depth calculation module configured to perform depth calculation on the corrected phase value to obtain a depth value; and
a depth filtration module configured to filter the depth value to obtain a filtered depth value.

29. The indirect time time-of-flight (iToF) depth calculation device according to claim 28, further comprising:
a gray scale calculation module configured to calculate a gray scale value according to the phase difference; and
an interface output module configured to output the filtered depth value and the gray scale value.

30. The indirect time time-of-flight (iToF) depth calculation device according to claim 28, wherein the parsed information further comprises exposure time information and temperature information, and wherein the phase correction module is configured to obtain a phase compensation value by fitting according to the temperature information, and correct the phase value according to the phase compensation value.

31. The indirect time time-of-flight (iToF) depth calculation device according to claim 30, further comprising:
an HDR module configured to read the phase difference and perform HDR calculation on long and short exposure characteristics of each pixel according to the exposure time information, so as to obtain an HDR-calculated phase difference, wherein the phase calculation module is configured to calculate the phase value according to the HDR-calculated phase difference.

32. The indirect time time-of-flight (iToF) depth calculation device according to claim 28, wherein the phase correction module is configured to calculate a phase compensation value based on calibration information of an iToF camera module, and correct the phase value according to the phase compensation value.

33. The indirect time time-of-flight (iToF) depth calculation device according to claim 28, further comprising:
an interface input module configured to receive optical signal information from an iToF camera module and send the optical signal information to the frame parsing module; and
a dual-frequency fusion module, wherein the depth value comprises a first depth value and a second depth value, the dual-frequency fusion module is configured to perform dual-frequency fusion calculation on the first depth value and the second depth value, so as to obtain a dual-frequency fused depth value, and the depth filtration module is configured to filter the dual-frequency fused depth value to obtain the filtered depth value.

34. The indirect time time-of-flight (iToF) depth calculation device according to claim 29, further comprising:
a point cloud calculation module configured to perform point cloud calculation on the filtered depth value to obtain a point cloud value;
a point cloud filtration module configured to filter the point cloud value to obtain a filtered point cloud value; and
a point cloud rotation module configured to rotate the filtered point cloud value to obtain a rotated point cloud value;
wherein the interface output module is configured to output the rotated point cloud value and the gray scale value.

35. The indirect time time-of-flight (iToF) depth calculation device according to claim 28, further comprising:
an AE module configured to calculate an exposure value in a current scene according to the phase difference;
a control module configured to configure configuration parameters of each module in the iToF depth calculation device, and
a cache module configured to store the configuration parameters and processed data from each module in the iToF depth calculation device.

36. An indirect time time-of-flight (iToF) depth calculation method, comprising:
converting, by a frame parsing module, optical signal information into parsed information, the parsed information comprising four-phase delay data, and the frame parsing module calculating a phase difference according to the four-phase delay data;
calculating, by a phase calculation module, a phase value according to the phase difference;
correcting, by a phase correction module, the phase value to obtain a corrected phase value;
performing, by a depth calculation module, depth calculation on the corrected phase value to obtain a depth value; and
filtering, by a depth filtration module, the depth value to obtain a filtered depth value.

37. The indirect time time-of-flight (iToF) depth calculation method according to claim 36, further comprising:
calculating, by a gray scale calculation module, a gray scale value according to the phase difference; and
outputting, by an interface output module, the filtered depth value and the gray scale value.

38. The indirect time time-of-flight (iToF) depth calculation method according to claim 36, wherein the parsed information further comprises exposure time information and temperature information; and wherein correcting, by the phase correction module, the phase value, comprises:
obtaining a phase compensation value by fitting according to the temperature information, and
correcting the phase value according to the phase compensation value.

39. The indirect time time-of-flight (iToF) depth calculation method according to claim 38, further comprising:
reading, by an HDR module, the phase difference, and performing HDR calculation on long and short exposure characteristics of each pixel according to the exposure time information, so as to obtain an HDR-calculated phase difference, wherein the phase calculation module calculates the phase value according to the HDR-calculated phase difference.

40. The indirect time time-of-flight (iToF) depth calculation method according to claim 36, wherein correcting, by the phase correction module, the phase value, comprises:
calculating a phase compensation value based on calibration information of an iToF module; and
correcting the phase value according to the phase compensation value.

41. The indirect time time-of-flight (iToF) depth calculation method according to claim 36, wherein the depth value comprises a first depth value and a second depth value, and the method further comprises:
receiving, by an interface input module, optical signal information from an iToF camera module,
sending the optical signal information to the frame parsing module;
performing, by a dual-frequency fusion module, dual-frequency fusion calculation on the first depth value and the second depth value, so as to obtain a dual-frequency fused depth value; and
filtering, by the depth filtration module, the dual-frequency fused depth value to obtain the filtered depth value.

42. The indirect time time-of-flight (iToF) depth calculation method according to claim 37, further comprising:
performing, by a point cloud calculation module, point cloud calculation on the filtered depth value to obtain a point cloud value;
filtering, by a point cloud filtration module, the point cloud value to obtain a filtered point cloud value;
rotating, by a point cloud rotation module, the filtered point cloud value to obtain a rotated point cloud value; and
outputting, by the interface output module, the rotated point cloud value and the gray scale value.

43. The indirect time time-of-flight (iToF) depth calculation method according to claim 36, further comprising:
calculating, by an AE module, an exposure value in a current scene according to the phase difference.

44. The indirect time time-of-flight (iToF) depth calculation method according to claim 36, further comprising:
configuring, by a control module, configuration parameters of each module in the iToF depth calculation device; and
storing, by a cache module, the configuration parameters and processed data from each module in the iToF depth calculation device.

45. An indirect time time-of-flight (iToF) camera module, comprising the iToF depth calculation device according to claim 28 wherein
the iToF depth calculation device is configured to process optical signal information to obtain depth value information and gray scale value information or point cloud value information and gray scale value information.

46. An indirect time time-of-flight (iToF) depth calculation system, comprising an iToF camera module, an AP chip and the iToF depth calculation device according to claim 28, wherein
the iToF camera module is configured to output optical signal information, the optical signal information is processed by the iToF depth calculation device to obtain depth value information and gray scale value information or point cloud value information and gray scale value information, and
the AP chip is configured to receive the depth value information and the gray scale value information or the point cloud value information and the gray scale value information.

47. The indirect time time-of-flight (iToF) depth calculation system according to claim 46, wherein the iToF camera module comprises the iToF depth calculation device, and the iToF depth calculation device in the iToF camera module is configured to process the optical signal information to obtain the depth value information and the gray scale value information or the point cloud value information and the gray scale value information.
